(19) United States
(12) Patent Application Publication
(10) Pub. No.: US 2008/0280372 A1
(43) Pub. Date: Nov. 13, 2008

(54) Continuous monitor for cyanide and cyanogen blood agent detection in water

(76) Inventors: Jeremy P. Walker, Oakmont, PA (US); Jon M. Washburn, JR., Pittsburgh, PA (US); Markus Erbeldinger, Pittsburgh, PA (US)

Correspondence Address: Craig G. Cochenour, Esq.;Buchanan Ingersoll & Rooney PC, 301 Grant Street, 20th Floor, One Oxford Centre, Pittsburgh, PA, 15219, US

(21) Appl. No.: 11/801,981

(22) Filed: May 11, 2007

(51) Int. Cl. G01N 21/75; G01N 21/01

(52) U.S. Cl. 436/109; 422/82.05

(57) ABSTRACT

A device for continuous detection of the presence of a cyanide analyte and/or cyanogen analyte in an aqueous sample which relies upon continuous sampling and controlled delivery of reagents for a chemical reaction which forms a colored dye in the presence of the analyte(s). The device employs a single chemical detection pathway which detects both cyanide and cyanogen and demonstrates continuous user-free operational stability over at least a one month period of time. The continuous monitoring device optionally may include a command post computer interface for enabling the remote monitoring of one or more devices, a wireless communication module for providing real-time data monitoring of the devices to a central monitoring facility, and a global positioning system module to enable the determination of an exact location of the analyte contamination in a water network. A method for detecting these analytes is also provided.

### GOVERNMENT INTEREST

Certain embodiments of this invention were made with Government support under Contract No. 0422090 SBIR Phase IIB awarded by the National Science Foundation. The Government has certain rights in the invention.

### FIELD OF THE INVENTION

The present invention relates to a device that employs a calorimetric chemical sensor to continuously monitor the environment for the presence of cyanide and cyanogen blood agent compounds. The invention is a device which is capable of continuous detection of the EPA-mandated safe drinking water limits for cyanide for time lengths of at least one month without degradation of the chemical components. Furthermore, the device is capable of running hands-free for at least one month and utilizes no toxic materials.

### BACKGROUND OF THE INVENTION

Cyanide is a potent blood agent which is very volatile and is also soluble in water as hydrogen cyanide (HCN) or cyanogen chloride (CNCl). Cyanide rapidly inhibits cellular respiration and can be lethal either by inhalation or oral intake. Cyanide is a very important analyte of interest due to its use as a chemical warfare agent as well as its pervasive presence in industrial processes such as electroplating, plastics processing, and fumigant manufacturing. The EPA has established a 0.2 mg/L (ppm) safe drinking water regulation level for cyanide. Whelton, A. J., Jensen, J. L., Richards, T. E., Valdivia, R. M., American Water Works Association Annual Conference and Exposition Proceedings (2003).

Typically, chemical techniques have been employed in the development of commercial point detection kits. Two general chemical methods are most prominent for point detection of cyanide, silver electrode techniques and calorimetric techniques.

The first technique relies upon the use of silver nitrate to titrate cyanide. Silver forms a soluble complex with cyanide below stoichiometry, potassium silver cyanide (KAg(CN)₂). At the endpoint of the titration (excess silver nitrate), an insoluble complex begins to form (AgCN), which precipitates. Several amperometric cyanide detection systems have been developed based upon this technology. The electrodes require frequent calibration in 0.1 N NaOH solution to detect the free cyanide ion (CN⁻), which only exists above pH 9.2. Samples require preparation through addition of an alkaline reagent which makes the sample pH basic. U.S. Pat. No. 6,001,240 is one such example of an electrochemical cyanide sensor which relies upon the reaction between silver and cyanide. The presence of cyanide removes silver from the electrode which is subsequently replaced by aqueous silver ions, establishing a potential which is dependent upon the cyanide concentration.

The second cyanide sensing approach utilizes several variations of the König reaction, in which a pyridine or a substituted pyridine molecule reacts with an oxidized cyanide (CN⁺) to form a dial compound, which subsequently reacts with a methylenecarbonyl compound, typically either pyrazolone or barbituric acid, to form a cyanine dye. The cyanide is typically initially oxidized through addition of an oxidizing agent such as hypochlorite or chloramine-T. The reaction of cyanogen halides to cleave pyridines was first used for dye synthesis in 1904. König, W. J. Prakt. Chem., 69, 105 (1904). Techniques employing pyridine are less desirable for point testing and continuous monitoring because pyridine is carcinogenic, noxious, thermally decomposes to HCN, and is harmful for the environment.

Subsequent development of the chemistry has led to utilization of more stable molecules for the König reaction. Lambert, J. L., Ramasamy, J., Paukstelis, J. V. Anal. Chem., 47, 916 (1975). Isonicotinic acid (4-pyridinecarboxylic acid) has been proven to work similarly to pyridine in the reaction with the oxidized cyanide species and subsequently with barbituric acid. Ausmus, E., Garschangen, H. Fresenius Z. Anal. Chem., 138, 414 (1953). Isonicotinic acid is a better component for test development than pyridine because it is non-toxic and does not thermally decompose into cyanide. Several colorimetric detection schemes as well as spectrofluorometric techniques have been developed based on this chemistry. Tanaka, A., Deguchi, K., Deguchi, T. Anal. Chim. Acta, 261, 281 (1992).

US Patent Application Publication No. 20040038419 describes a fluorescence assay for cyanide which relies upon the formation of a fluorescent compound in the presence of cyanide. The reaction involves a catalytic pathway which either measures directly produced cyanide or materials which can be readily converted to cyanide. The cyanide subsequently reacts with an aromatic compound to produce a fluorescent molecule.

Current techniques for point testing of cyanide are very sensitive and are semi-quantitative, however there is a demand for continuous monitoring systems which are capable of hands-free detection and reporting of the presence of cyanide. A device that is capable of continuous user-free monitoring which can detect and even quantify the presence of cyanide/cyanogen compounds would be of significant utility for many applications including but not limited to monitoring of treated drinking water for military personnel and for buildings of high importance such as schools and government offices, monitoring industrial cleanup and emissions, and detection of environmental contamination.

Several devices have previously been developed for the continuous or semi-continuous monitoring of cyanides. These systems utilize a variety of detection techniques including calorimetric detection, piezoelectric devices, and detection of biological metabolites.

U.S. Pat. No. 4,871,681 describes a continuous flow calorimetric device which relies upon the reaction between cyanide and the explosive compound picric acid (2,4,6-trinitrophenol). This reaction forms an isopurpurate dye in the presence of cyanide. The device is useful for monitoring total cyanide because it utilizes an enclosed gas-tight system which allows acidification of the sample to remove complexed cyanide from metal chelators without loss of HCN due to gas formation. The device is useful as a monitor of total cyanide, however it does employ an explosive compound for the colorimetric detection chemistry, which could be dangerous for long term storage and/or operation under harsh temperature conditions.

US Patent Application Publication 20020151082 describes a continuous flow cyanide monitor equipped with a gold coated quartz piezoelectric microbalance inside the flow cell. Gold displays reactivity to cyanide which is similar to the silver chemistry, but with a lower degree of interference from thiocyanate. When cyanide is present, the gold forms 1:2 Au:CN complexes with cyanide and becomes aqueous. The loss of mass affects the frequency of oscillation of the quartz microbalance, which is correlated with the cyanide concentration. This technique appears to have linear detection range over the 0.2-1 ppm concentration level. This application claims that the device can measure 50 ppb-100 ppm HCN, and requires periodic calibration with standard solutions.

US Patent Application Publication 20050084419 describes a flow system for detecting toxic agents in water by monitoring the photosynthetic activity of naturally occurring organisms in the water sample. The system measures the decrease in chlorophyll production via fluorescence and requires dark adaptation of the organisms prior to sample measurement. The patent shows that the fluorescence decreases in the presence of both cyanide and the pesticide methyl parathion, thus the device serves as a general method for measuring the presence of toxic compounds in water samples, however the device is incapable of determination of the specific class of compound (i.e. blood agent, nerve agent, etc.).

US Patent Application Publication 20060073490 discloses an enzyme-based device for environmental monitoring. This device employed a continuous flow system with integrated enzyme-containing polymers which are capable of detecting numerous analytes. The device is capable of continuous monitoring of enzyme activity and utilizes changes in the activity to indicate the presence of target analytes which specifically inhibit the enzyme polymer. One such application of this invention is a device which continuously monitors water for the presence of nerve agents using an enzymatic biopolymer. The presence of nerve agent causes a reduction in the catalysis of the enzyme's substrate, which in turn causes a decrease in the colorimetric signal.

Continuous biosensors incorporating enzymes could be developed to detect cyanide and cyanogens. Enzymes have been noted to be useful in the detection of chemical species since the 1960s. Rogers, K. R. Biosensors Bioelectronics 10, 533 (1995). However, cyanide and cyanogen act to inhibit different enzymes, so multi-component systems which employ separate enzymes are required for detection of cyanide and cyanogen. Thus it is impossible to make a one-component biosensor which detects both forms of blood agent.

### SUMMARY OF THE INVENTION

The present invention describes a device for long-term continuous monitoring for the presence of cyanide and cyanogen blood agents in environmental and treated water sources. As used herein, the term “long-term” is defined as a length of time ranging from one month to two years, and preferably greater than several years. It will be understood that the various chemical components employed in the device of the present invention as described herein shall require periodic replacement for the device and method to operate on a long-term continuous basis. The device employs an oxidizing agent to convert cyanide to cyanogen chloride, followed by the very specific modified König reaction which occurs between the cyanogen and isonicotinic acid and barbituric acid to form a cyanine dye. The invention preferably employs microfluidic pumps to mix pre-determined quantities of analyte with a solution of isonicotinic and barbituric acid in a near neutral buffer solution. As used herein, the term “near neutral” is defined as a pH ranging from 5 to 8. The solution pumps provide sufficient mixing before the oxidizing agent, such as for example but not limited to, sodium hypochlorite, is introduced. The solution pumps are then idle for a defined period of time, ranging for example but not limited to, from about at least thirty (30) seconds, to preferably at least about one minute, and more preferably from about 30 seconds to 15 minutes, to allow for the formation of a dye in the presence of cyanide. The dye formation is monitored using a commercially available LED light source and a commercially available photodiode reader which continuously reports the intensity of the reflected light.

The present invention provides a continuous monitoring device for detecting the presence of cyanide or cyanogen chloride in an aqueous sample comprising a first conduit having a first end and a second end, the first end of the first conduit for receiving a first phase of an aqueous process stream that is an aqueous sample that may or may not contain a cyanide or cyanogen analyte; a first reservoir for containing a mixture of dye precursor compositions comprising a substituted pyridine compound and a methylenecarbonyl compound; a first mechanism for delivering the mixture of the dye precursor compositions from the first reservoir to the first conduit having the first phase of the aqueous process stream comprising the sample thereby forming a second phase of the aqueous process stream having the aqueous sample and the mixture of the dye precursor compositions; a second mechanism for delivering the second phase of the aqueous process stream from the second end of the first conduit to a first end of a second conduit thereby forming a third phase of the aqueous process stream; a second reservoir in communication with the third conduit and wherein the second reservoir contains an oxidizing agent; a third mechanism for delivering the oxidizing agent from the second reservoir to the second conduit having the third phase of the aqueous process stream; a flow cell in communication with a second end of the second conduit, wherein the flow cell is transparent to light (and preferably, the flow cell is transparent to visible light), and is capable of receiving the third phase of the aqueous process stream containing the aqueous sample, the mixture of dye precursor compositions, and the oxidizing agent; a light source for delivering light to the flow cell; and a color reading sensor for detecting the output reflectance intensity of the light delivered to the flow cell for determining the presence or absence of the cyanide analyte or the cyanogen chloride analyte in the aqueous sample. In a preferred embodiment, the aqueous sample is an environmental water sample or a treated water sample.

In another embodiment of the present invention, the continuous monitoring device, as described herein, further comprises a computer processor for storing and analyzing the output reflectance intensity.

In a preferred embodiment of the continuous monitoring device of this invention, the substituted pyridine compound and methylenecarbonyl compound are delivered to the first phase of the aqueous process stream in a buffered solution to maintain near neutral pH conditions to promote formation of a cyanine dye in the presence of the cyanide analyte or the cyanogen chloride analyte, or both. More preferably, the continuous monitoring device of this invention includes wherein the substituted pyridine is isonicotinic acid (4-pyridinecarboxylic acid), and the methylenecarbonyl compound is barbituric acid, and wherein the oxidizing agent is hypochlorite or chloramine-T.

Another embodiment of the continuous monitoring device of the present invention provides wherein the oxidizing agent is subsequently delivered to the third phase of the aqueous process stream after a residence time, for example ranging from about one minute to ten minutes, which is sufficient for the aqueous sample and the mixture of a buffered isonicotinic acid and barbituric acid to adequately mix in the first conduit. Preferably, the continuous monitoring device provides wherein the aqueous sample, the mixture of the dye precursor compositions, and the oxidizing agent are delivered in a continuous cycle at fixed proportions.

The continuous monitoring device, as described herein, provides for the monitoring and recording by a color reading sensor of the intensity of the cyanine dye formed. Preferably, the color reading sensor is an RGB color to frequency converter.

In a preferred embodiment of the continuous monitoring device of the present invention, the first, second, and third mechanisms are each a pump capable of delivering microliter to milliliter volumes.

Preferably, the continuous monitoring device of the present invention includes wherein the computer processor is capable of reading data output from the color reading sensor and analyzing the data to determine whether a cyanide analyte or cyanogen analyte, or both, detection event occurs.

The continuous monitoring device of the present invention, as described herein, may further comprise a microcontroller for collecting and analyzing said data and for determining if the cyanide analyte or the cyanogen analyte, or both, is present in the aqueous sample by detecting a decrease in the color intensity.

The continuous monitoring device of the present invention, as described herein, may further comprise a command post computer interface for enabling the remote monitoring of said data recorded by one or more continuous monitoring devices. More preferably, the continuous monitoring device, as described herein, comprises a wireless communication module for providing real-time data monitoring of one or more continuous monitoring devices to a central monitoring facility. Most preferably, the continuous monitoring device, as described herein, comprises a global positioning system module for remote deployment of multiple continuous monitoring devices to enable the determination of an exact location of said analyte(s) contamination in a water network.

The present invention provides a device for simultaneous detection of both cyanide and cyanogens utilizing a single chemical pathway. Furthermore, the device is capable of hands-free operation for at least one month without requiring replacement of the chemicals, as described herein, located in the first and second reservoirs. An added advantage to this device and method of the present invention is that they do not generate any hazardous effluents.

The present invention also provides for a method for detecting the presence of cyanide or cyanogen chloride or both in an aqueous sample. The method preferably comprises providing a command post computer interface for enabling the remote monitoring of the data recorded by one or more of continuous monitoring devices described herein. More preferably, the method comprises providing a wireless communication module for providing real-time data monitoring of one or more continuous monitoring devices to a central monitoring facility. Most preferably, the method comprises providing a global positioning system module for remote deployment of multiple continuous monitoring devices of this invention for enabling the determination of an exact location of the analyte(s) contamination in a water network.

### BRIEF DESCRIPTION OF THE DRAWINGS

FIG. 1 is a schematic of the present invention.

FIG. 2 illustrates the response of the present invention to varying concentrations of hydrogen cyanide.

FIG. 3 shows the continuous response of the present invention to varying concentrations of hydrogen cyanide and cyanogen bromide.

### DETAILED DESCRIPTION OF THE INVENTION

The present invention is a continuous flow water monitoring system which is capable of detecting aqueous hydrogen cyanide at the EPA-mandated safe drinking water concentration levels (0.2 ppm) as well as 0.5 ppm cyanogen bromide, a stimulant of cyanogen chloride. The system relies upon a calorimetric reaction which occurs only in the presence of cyanide and cyanogen species. The present invention provides a method to continuously monitor incoming water for the presence of cyanide and cyanogens with a specific colorimetric chemistry employing the device of the present invention. The device has a proven operational stability of at least one month and produces no toxic effluent in the waste stream.

The present invention provides a continuous monitoring device for detecting the presence of cyanide or cyanogen chloride in an aqueous sample comprising a first conduit having a first end and a second end and a middle section disposed between the first and second ends, wherein the first end of the first conduit is capable of receiving a first phase of an aqueous process stream that is an aqueous sample that may or may not contain a cyanide analyte or cyanogen analyte, a first reservoir in communication with the middle section of the first conduit, wherein the first reservoir contains a mixture of dye precursor compositions comprising a substituted pyridine compound and a methylenecarbonyl compound, a first mechanism for delivering the mixture of the dye precursor compositions from the first reservoir to the first conduit having the first phase of the aqueous process stream comprising the sample thereby forming a second phase of the aqueous process stream having the aqueous sample and the mixture of dye precursor compositions, and a second mechanism for delivering the second phase of the aqueous process stream from the second end of the first conduit to a first end of a second conduit thereby forming a third phase of the aqueous process stream. The second conduit has a first end and a second end and a middle section disposed between the first and second ends. The device of this invention comprises a second reservoir in communication with the middle section of the second conduit and wherein the second reservoir contains an oxidizing agent, a third mechanism for delivering the oxidizing agent from the second reservoir to the second conduit having the third phase of the aqueous process stream, and a flow cell in communication with the second end of the second conduit. The flow cell is transparent to light and is capable of receiving the third phase of the aqueous process stream containing the aqueous sample, the mixture of the dye precursor compositions, and the oxidizing agent. The device of this invention comprises a light source for delivering light to the flow cell, and a color reading sensor for detecting the output reflectance intensity of the light delivered to the flow cell for determining the presence or absence of the cyanide analyte or the cyanogen chloride analyte, or both, in the aqueous sample. Preferably, the light is electromagnetic radiation having a wavelength in the range that may be perceived by an unaided human eye and is for example, but not limited to white light.

In another embodiment of the continuous monitoring device of the present invention, as described herein, the device further comprises a computer processor for storing and analyzing said output reflectance intensity.

The aqueous sample is preferably an environmental water sample or a treated water sample. Preferably, the substituted pyridine compound and methylenecarbonyl compound are delivered to the first phase of the aqueous process stream in a buffered solution to maintain near neutral pH conditions (a pH ranging from 5 to 8) to promote formation of a cyanine dye in the presence of the cyanide analyte or the cyanogen chloride analyte, or both. More preferably, the substituted pyridine is isonicotinic acid (4-pyridinecarboxylic acid), and the methylenecarbonyl compound is barbituric acid, and the oxidizing agent is hypochlorite or chloramine-T.

Preferably, the continuous monitoring device of this invention and the method of detecting the presence of cyanide and cyanogen chloride in an aqueous sample include wherein the aqueous sample is initially delivered to the first conduit and aqueous process stream at a flow rate in excess of 100 milliliters per hour for a period of time ranging from about five seconds to three minutes to clean out all phases of the aqueous process stream and to introduce fresh aqueous sample.

The continuous monitoring device and method includes wherein the oxidizing agent is subsequently delivered to the third phase of the aqueous process stream after a residence time which is sufficient for the aqueous sample and the mixture of a buffered isonicotinic acid and barbituric acid to adequately mix in the first conduit.

In a more preferred embodiment of the device and method of this invention, the aqueous sample, the mixture of the dye precursor compositions, and the oxidizing agent are delivered in a continuous cycle at fixed proportions, as set forth in detail in the experimental procedure section herein.

In the device and method of this invention, the intensity of the cyanine dye formed is monitored and recorded by said color reading sensor. Preferably, the color reading sensor is an RGB (red, green, blue) color to frequency converter. The data from the color reader sensor are recorded for later analysis. Preferably, the data is directly output from the device.

Another embodiment of the continuous monitoring device of this invention, as described herein, includes wherein the first, second, and third mechanisms are preferably each a pump capable of delivering microliter to milliliter volumes. The turbulence produced by the flow rates of the pumps as well as the internal diameter of the first and second conduits (preferably having an internal diameter from 0.079 centimeters to 0.32 centimeters) provides for the sufficient mixing of the aqueous sample (with or without cyanide or cyanogen chloride analytes) and the mixture of the dye precursor compositions in the first conduit, and the aqueous sample (with or without cyanide or cyanogen chloride analytes), mixture of dye precursor compositions and the oxidizing agent in the second conduit, without the need for a special mixing chamber(s) or stage(s).

The continuous monitoring device of this invention includes a computer processor that is capable of reading data output from the color reading sensor and for analyzing the data to determine whether a cyanide analyte or cyanogen analyte detection event occurs. The continuous monitoring device further comprises a microcontroller for collecting and analyzing the data and for determining if the cyanide analyte or the cyanogen analyte, or both, is/are present in the sample by detecting a decrease in the color intensity.

In another embodiment of this invention, a continuous monitoring device is provided, as described herein, further comprising a command post computer interface for enabling the remote monitoring of the data recorded by one or more continuous monitoring devices. The continuous monitoring device may comprise a wireless communication module for providing real-time data-monitoring of one or more continuous monitoring devices to a central monitoring facility. In yet another embodiment of this invention, the continuous monitoring device, as described herein, comprises a global positioning system module for remote deployment of multiple continuous monitoring devices to enable the determination of an exact location of the analyte(s) contamination in a water network. The water network may be such as for example, but not limited to, a municpal water system, a water system for one or more buildings, or an irrigation water system. The continuous monitoring system of this invention may be equipped with a wireless communication system, such as an IEEE 802.11b/g wireless module with encryption technology, for example but not limited to, a WiPort Embedded Device Server (Lantronix, Irvine, Calif.). In the alternative, the continuous monitoring device may be equipped with an Ethernet port. The continuous monitoring device may comprise an advanced command post commuter interface with or without a global positioning system (GPS) module, such as for example but not limited to the Kyocera GPS module (San Diego, Calif.). The wireless communication module and the GPS module shall allow remote deployment of multiple continuous monitoring devices of this invention which may operate simultaneously and provide real-time data to a central monitoring facility. Use of multiple deployed continuous monitoring devices of this invention shall enable a user of the device to determine the exact location and to track the spread of analyte (i.e. cyanide analyte or cyanogen chloride analyte, or both) contamination in a water network.

The present invention also provides a method for detecting the presence or absence of cyanide or cyanogen chloride, or both, in an aqueous sample comprising delivering an aqueous sample to a first phase of a process stream wherein the aqueous sample that may or may not contain a cyanide or cyanogen analyte, providing a first reservoir for containing a mixture of dye precursor compositions comprising a substituted pyridine compound and a methylenecarbonyl compound, delivering the mixture of the dye precursor compositions from the first reservoir to the first phase of the aqueous process stream comprising the aqueous sample thereby forming a second phase of the aqueous process stream, effecting mixing of the second phase for forming a mixed second phase, delivering the mixed second phase of the aqueous process stream to a third phase of the aqueous process stream, providing a second reservoir that is in communication with the third phase of the aqueous process stream and wherein the second reservoir contains an oxidizing agent, delivering the oxidizing agent from the second reservoir to the third phase of the aqueous process stream either before, after or at the same time that the mixed second phase of the aqueous process stream is delivered to the third phase of the aqueous process stream, providing a flow cell that is transparent to light (and preferably, the flow cell is transparent to visible light) and that is capable of receiving the third phase of the aqueous process stream containing the aqueous sample, the mixture of dye precursor compositions, and the oxidizing agent, delivering the third phase of the aqueous process stream containing the aqueous sample, mixture of dye precursor compositions, and oxidizing agent to the flow cell for analysis, providing a light source for delivering light to the flow cell, delivering the light to the flow cell, providing a color reading sensor for detecting the output reflectance intensity of the light delivered to the flow cell, and detecting the output reflectance intensity of the light for determining the presence or absence of the cyanide analyte or the cyanogen chloride analyte, or both analytes, in the aqueous sample. Preferably, the method includes delivering the oxidizing agent to the third phase of the aqueous process stream after a residence time which is sufficient, typically a time period ranging from five seconds to three minutes, for the aqueous sample and a mixture of a buffered isonicotinic acid and barbituric acid to adequately mix in the second phase.

Yet another embodiment of the present invention provides a method, as described herein, that further comprises discharging the analyzed third phase of the aqueous process stream from the flow cell to form an effluent (waste stream), and repeating the steps of the above described method for one or more cycles for effecting a continuous monitoring of the aqueous process stream. The number of cycles that are performed is limited only by the availability of chemicals in the reservoirs as described herein.

In another embodiment of the method of the instant invention, as described herein, the method comprises providing a computer processor for storing and analyzing the output reflectance intensity and wherein the computer processor is capable of reading data output from the color reading sensor and for analyzing the data to determine whether a cyanide analyte or a cyanogen analyte or both analyte detection event(s) occur(s).

Yet other embodiments of the method of the present invention, as described herein, further comprise providing a command post computer interface for enabling the remote monitoring of the data recorded by one or more continuous monitoring devices. This method may also further comprise providing a wireless communication module for providing real-time data monitoring of one or more continuous monitoring devices to a central monitoring facility. Further, this method may further comprise providing a global positioning system module for remote deployment of multiple continuous monitoring devices for enabling the determination of an exact location of the analyte(s) contamination in a water network.

The utility and significance of the modified König reaction is that it is the only reaction which permits simultaneous detection of either cyanide or cyanogen chloride. The hypochlorite oxidizes cyanides to form cyanogen chloride, which then subsequently reacts with isonicotinic acid and barbituric acid to form the dye.

There are several specific operational and hardware requirements for construction of a viable cyanide monitoring device. The analyte must be treated with a sufficient amount of a buffer that makes the solution have a near neutral pH. This is necessary because although it is an enclosed system, the HCN can become gaseous at acidic pH, while CNCl is volatile at basic pH. The buffer helps to maintain a consistent environment in the chamber so that the cyanide can be quantified. Also, the buffer provides a moderate environment in which both the cyanide oxidation and the colorimetric reactions can proceed.

In addition, the chemicals used for the calorimetric detection must meet certain criteria in order to be acceptable for reliable long-term continuous monitoring of cyanide. The materials must stay dissolved and must not undergo significant thermal degradation over an extended operational time. Also, dry powder preparations of the chemicals must remain viable over extended shelf storage lifetimes as well, for example, preferably at least two years.

The fluid delivery system for the analyte, buffered isonicotinic acid and barbituric acid solution, and sodium hypochlorite solution must be maintainable and precise for long operational periods. Deviations in fluid delivery rates or cycle times amounting to an excess of 20% by volume may result in poor detection performance and may generate erroneous data.

Furthermore, the order of delivery of the chemicals is very important as well. The isonicotinic acid and barbituric acid must be introduced first to allow adequate mixing, and cannot be pre-mixed with the hypochlorite because they will be oxidized, which will significantly reduce the availability of both the acids and the hypochlorite.

Also, in the absence of cyanide the device should display a smooth, continuous operational baseline which is free of false positive responses caused by environmental stimuli or chemical interferents. The device of the present invention has a fluid delivery system that avoids and/or minimizes effects which may cause significant deviations in the baseline signal during operation.

The device includes delivery of the analyte sample at a high rate of flow defined as greater than 100 milliliters per hour (ml/hr) which serves the purpose of flushing out the system as well as introducing fresh sample for analysis. A first mechanism delivers a solution containing isonicotinic acid and barbituric acid as well as a buffer to stabilize the final pH of the aqueous process stream (system) between 5 and 8. The third phase includes providing the oxidizing agent, such as for example but not limited to sodium hypochlorite, to the third phase of the aqueous process stream for converting the cyanide to cyanogen chloride and initiating the formation of the dye.

### Experimental Procedures

### 1. Colorimetric Detection of Cyanide

As known in the art, point calorimetric detection of cyanide in aqueous samples requires the use of two separate additives for cyanide detection. Typically, the first additive is a mixture of the dye precursor compositions comprising a substituted pyridine and a methylenecarbonyl compound, while the second additive contains an oxidizing agent which oxidizes the cyanide to cyanogen chloride. The resultant cyanogen chloride subsequently cleaves the substituted pyridine and forms a 2-pentenedial derivative. This compound then reacts with two molecules of the active methylenecarbonyl compound, such as for example but not limited to barbituric acid or pyrazolone, to form a cyanine dye.

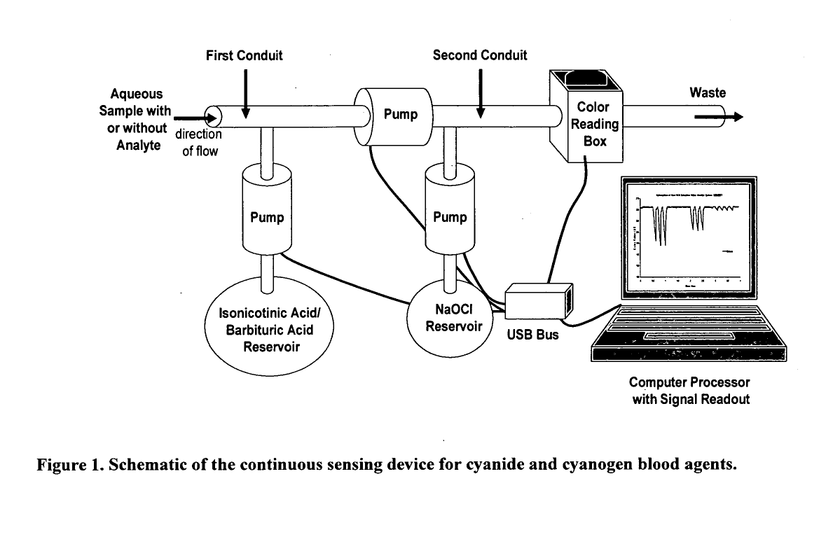

FIG. 1 illustrates the device which is used for online continuous detection of cyanide or cyanogen chloride. Described below is a typical method used in the present invention for cyanide or cyanogen chloride detection. In a preferred embodiment of this invention, the continuous water monitoring system utilizes at least three pumps to deliver three solutions necessary for the reaction. The pump can be any type which is capable of delivering microliter to milliliter quantities of solutions. The software for controlling the pumps was designed using National Instruments' LabVIEW 8.2 software (Austin, Tex.). The conduit utilized preferably has an inner diameter ranging from 0.079 centimeters (cm) to 0.32 cm. Solution reservoir bags are able to contain up to 3 L (liter) of solution for continuous unmonitored operation for at least 1 month.

The analyte if present in the aqueous water sample is delivered (for example, optionally by use of a pump not shown in FIG. 1) to the first phase of the aqueous process stream from the source. Initially, the aqueous sample (with or without analyte) is delivered to the aqueous process stream for 1 to 3 minutes at a flow rate in excess of 100 ml/hr to flush out the system and to deliver a fresh sample for analysis. In the second phase of the cycle, the aqueous process stream (with or without analyte) is pumped at a flow rate between 60 and 120 ml/hr. Also in the second phase, a pump delivers a solution of 0.5 to 30 mM isonicotinic acid and 0.1 to 70 mM barbituric acid in 1 to 50 mM phosphate buffer at a rate of 10 to 70 ml/hr. The second phase preferably lasts over a time period ranging from five seconds to three minutes. In the third phase, another pump delivers a small amount of 0.1 to 5% sodium hypochlorite (NaOCl) solution at a flow rate of 5 to 20 ml/hr. The sodium hypochlorite is added farther downstream from the isonicotinic acid/barbituric acid solution to permit adequate mixing of the aqueous sample stream (with or without analyte) with the isonicotinic acid/barbituric acid stream. This short residence time ranging from five seconds to three minutes is important because early addition of bleach can excessively oxidize the dye precursor compositions instead of the cyanide. In the second phase, all pumps operate between five seconds to three minutes. In the resultant solution, the analyte accounts for 50% (v/v) to 60% (v/v) of the solution volume, the isonicotinic acid/barbituric acid in phosphate buffer is 20% (v/v) to 30% (v/v) of the solution, and the sodium hypochlorite accounts for 5% (v/v) to 15% (v/v) of the liquid volume.

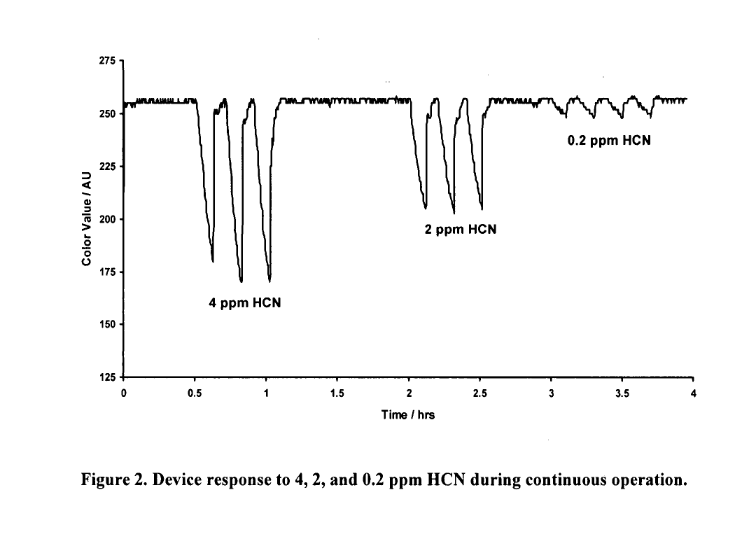

In the final phase of the cycle, all pumping is stopped for a period of time ranging from about thirty seconds to about fifteen minutes to allow the reaction to occur in the flow cell. At this point, the solution is in a flow cell that is transparent to light. A commercial white light LED source which pulses every fifteen seconds is affixed perpendicular to the flow cell. Also affixed perpendicular to the flow cell is a simple commercially available photodiode with an RGB (red, green, blue) color to frequency converter and micro-controller system (TAOSinc, Texas Advanced Optoelectronic Solutions, Plano, Tex.). Outputs from the RGB monitor are stored on a computer processor, for example a laptop computer. The solution in the flow cell is completely clear and exhibits a high reflectance intensity in the absence of blood agent. If cyanide or cyanogen chloride is present in the aqueous sample, the formation of the cyanine dye increases the absorbance of the incident LED light by the solution in the flow cell, which decreases the intensity of the reflected light. The decrease in reflected light corresponds to a drop in the intensity of the RGB values. FIG. 2 displays a typical signal output from the device in response to a series of HCN solution spikes. Two consecutive peaks are shown for each spike corresponding to two cycles each of exposure to concentrations of 4, 2, and 0.2 ppm HCN, respectively.

The presence of cyanide or cyanogen causes a consistent drop in the RGB values as the reaction proceeds. Subsequent removal of the dye by the fast flush cycle allows the system to return to the baseline. The repeated cycles of fluid delivery and color development allow for continuous hands-free detection of cyanide and cyanogen for at least one month and preferably up to and including two years, and more preferably greater than two years.

### 2. Response and Sensitivity to Cyanide and Cyanogen Bromide

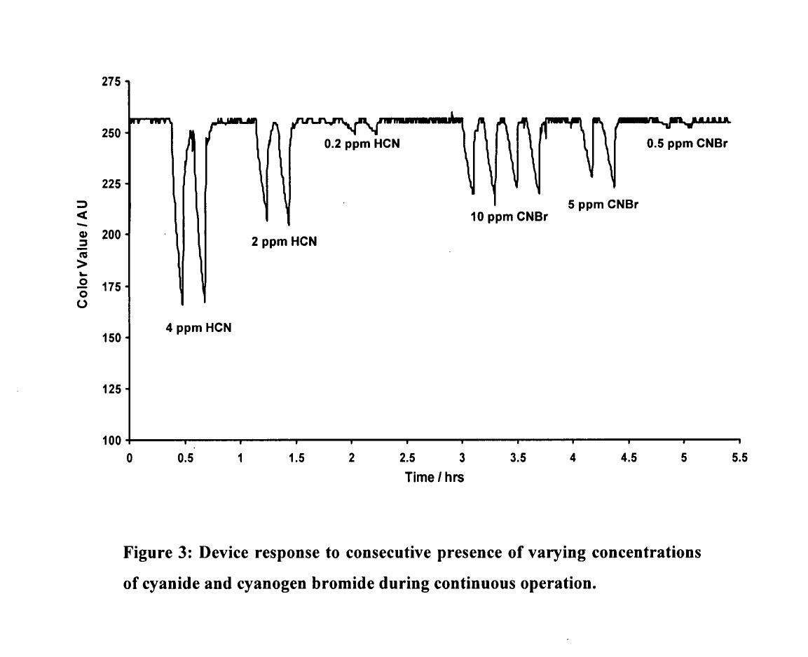

Identical hardware and operational conditions, as set forth herein, were utilized to continuously monitor a water sample in order to demonstrate detection of both hydrogen cyanide (HCN) and cyanogen bromide (CNBr), a surrogate for cyanogen chloride. The system was allowed to run for about 20 minutes to allow establishment of a consistent baseline signal. HCN and CNBr solutions were prepared separately through serial dilution of freshly-prepared stock 200 ppm potassium cyanide and 200 ppm cyanogen bromide diluted with an artificial tap water solution, respectively. The analyte was replaced with 4 ppm hydrogen cyanide and two full cycles of sensing were permitted to run. Afterward, the pure analyte sample (i.e. the sample free of cyanide and cyanogen chloride) replaced the cyanide spike. After about 15 minutes, a 2 ppm cyanide sample was introduced, followed by a 0.2 ppm cyanide sample via the aforementioned protocol. The system was subsequently exposed to 10 ppm (4 cycles), 5 ppm, and 0.5 ppm cyanogen bromide solutions. FIG. 3 shows the response of the system to the cyanide and cyanogen bromide spikes. The observed response is due to the formation of a cyanine dye via the isonicotinic acid/barbituric acid calorimetric modified König reaction mechanism. The signal is very robust and consistent, and the results can be interpreted semi-quantitatively. The invention can be utilized to continuously monitor both environmental and drinking water sources for the presence of cyanide and cyanogen bromide.

### 3. Interference Testing

The invention herein was subjected to a host of interference tests to prove that the hardware and chemistry were robust enough to enable the detection of cyanide in the presence of other interfering chemical compounds such as for example those set forth in Table 1. Below is a typical protocol for the interference testing.

1-10% (v/v) samples of potential interferent chemical species were diluted in artificial tap water. The device was run for 30 minutes under normal conditions to establish a baseline. At this point, the interferent solution replaced the artificial tap water as the analyte source. The system was run for an additional 30 minutes under these conditions to determine whether the interferent disrupted the baseline and caused a false detection event. Finally, a serial dilution of cyanide was prepared with the interferent solution. The system was subsequently challenged with several different concentrations of cyanide. The signal was compared to the cyanide response signals that occur in the absence of the potential interferent to determine whether any interference of cyanide detection occurred. Table 1 lists the interferents which were tested.

The interference studies demonstrate that the detection chemistry works very well in the presence of a host of chemical species. There appear to be only a few compounds which interfere with detection of cyanide in aqueous samples. Chlorine, Clorox bleach (Clorox, Oakland, Calif.) and peroxide are oxidizing agents which destroy cyanide when the molar ratio of oxidizing agent to cyanide is between five and ten. One experiment demonstrated a detection limit of 2 ppm HCN in 5 ppm chlorinated tapwater.

Also, Mr. Clean™ cleaning solution (Procter & Gamble, Cincinnati, Ohio) contains ammonium which reacts violently with the sodium hypochlorite and causes significant gas bubble formation in the device. If the bubbles are large, particularly if they span the width of the entire flow cell, they can cause false positive readings due to interference with the optical detection of the device. Finally, thiocyanate also causes a false positive reaction because it is very close to hydrogen cyanide in structure and can also participate in the König reaction.

TABLE 1
Results of interference studies for chemical species and solvents with
cyanide and cyanogen blood agent detection.

| | Blood Agent |
|---|---|
| Interferent | Interference (Y/N) |
| acidic pH: pH 4 with HCl | N |
| acidic pH: pH~4 with Acetic Acid | N |
| basic pH: pH 10 with NaOH | N |
| Sea Salts (high Salinity) | N |
| Chlorinated tapwater (5 ppm) | N¹ |
| Sodium thiosulfate | N |
| methanol (1%) | N |
| ethanol (1%) | N |
| isopropanol (1%) | N |
| Windex (1%) | N |
| peroxide (3%) | N¹ |
| Gasoline (saturation) | N |
| Vinegar (1%) | N |
| Clorox (1%) | N¹ |
| Sugar (1%) | N |
| Mr. Clean ™ (1%) | Y² |
| Acetone (1-10%) | N |
| Toluene | N |
| Potassium thiocyanate | Y³ |

Legend:
¹neutralizes CN below stoichiometry
²bubble formation interferes with optics
³false positive

### 4. Stability Studies

Stability studies were conducted to determine both the operational and storage stabilities of the chemical components of the system. Dry powder formulations of the isonicotinic acid/barbituric acid and phosphate buffer were stored at a constant temperature of 60° C. for one month in an advanced aging study which correlates with a shelf life in excess of one year. The powders were dissolved in deionized water and were tested via the aforementioned protocol. The device was exposed to 4, 2, and 0.2 ppm samples of hydrogen cyanide. The device response was identical to the response generated by a freshly-prepared solution, indicating that the powders are stable during this time.

The stability of the isonicotinic acid/barbituric acid solution and the hypochlorite solution was also tested. In one experiment, the solutions were stored in a cabinet at ambient laboratory conditions (˜25° C.) for one month. The solutions were subsequently exposed to cyanide spikes via the aforementioned protocol and demonstrated full response to concentrations of 4, 2, and 0.2 ppm HCN. These findings illustrate that the chemical components are fairly stable at ambient conditions.

To further investigate the stability, the isonicotinic acid/barbituric acid solution and the hypochlorite solution were stored in an oven at a constant 40° C. temperature for a full month. Aliquots of the solution were tested at 1 week, 2 week, and 1 month time points. The solutions were tested via the aforementioned protocol with 4, 2, and 0.2 ppm HCN spikes. The solutions displayed full responses after 1 and 2 weeks of storage and demonstrated only a slightly diminished response after 1 month of storage at 40° C. These findings indicate that the chemical components display sufficient stability for continuous operation at elevated temperatures.

### 5. Response to Cyanide in Environmental Samples

The present invention was rigorously tested in the laboratory and demonstrated excellent performance in the interference studies. To demonstrate the utility of the invention for monitoring cyanide and cyanogen chloride blood agent in environmental samples, the device was exposed to several unfiltered, unaltered water samples gathered from various points in the Allegheny River in Verona and Oakmont, Pa. Solutions of concentration 4, 2, and 0.2 ppm hydrogen cyanide were prepared via serial dilution with the river water samples. The device was challenged with the river water according to the aforementioned testing protocol. The turbidity of the water caused a slight decrease in the baseline intensity compared with the standard laboratory test, however the baseline was smooth. The system was clearly able to detect all of the cyanide spikes. Only a slight reduction in the signal was observed, possibly due either to complexation of cyanide with naturally-present metal cations or interaction with microorganisms. This study demonstrates that the present device and method can reliably be used to monitor the presence of blood agents in environmental samples without need for significant sample treatment or preparation.

Whereas particular embodiments of the instant invention have been described for the purposes of illustration, it will be evident to those persons skilled in the art that numerous variations and details of the instant invention may be made without departing from the instant invention as defined in the appended claims.

What is claimed is:

1. A continuous monitoring device for detecting the presence of cyanide or cyanogen chloride in an aqueous sample comprising:
a first conduit having a first end for receiving a first phase of an aqueous process stream that is an aqueous sample that may or may not contain a cyanide analyte or cyanogen analyte;
a first reservoir in communication with said first conduit, wherein said first reservoir contains a mixture of dye precursor compositions comprising a substituted pyridine compound and a methylenecarbonyl compound;
a first mechanism for delivering said mixture of said dye precursor compositions from said first reservoir to said first conduit having said first phase of said aqueous process stream comprising said sample thereby forming a second phase of said aqueous process stream having said aqueous sample and said mixture of dye precursors;
a second mechanism for delivering said second phase of said aqueous process stream from a second end of said first conduit to a first end of a second conduit thereby forming a third phase of said aqueous process stream;
a second reservoir in communication with said third conduit, wherein said second reservoir contains an oxidizing agent;
a third mechanism for delivering said oxidizing agent from said second reservoir to said second conduit having said third phase of said aqueous process stream;
a flow cell in communication with a second end of said second conduit, wherein said flow cell is transparent to light and is capable of receiving the third phase of said aqueous process stream containing said sample, said mixture, and said oxidizing agent;
a light source for delivering light to said flow cell; and
a color reading sensor for detecting the output reflectance intensity of said light delivered to said flow cell for determining the presence or absence of the cyanide analyte or the cyanogen chloride analyte in said aqueous sample.

2. The continuous monitoring device of claim 1 comprising a computer processor for storing and analyzing said output reflectance intensity.

3. The continuous monitoring device of claim 1 wherein said aqueous sample is an environmental water sample or a treated water sample.

4. The continuous monitoring device of claim 1 wherein said substituted pyridine compound and methylenecarbonyl compound are delivered to said first phase of said aqueous process stream in a buffered solution to maintain near neutral pH conditions to promote formation of a cyanine dye in the presence of said cyanide analyte or said cyanogen chloride analyte.

5. The continuous monitoring device of claim 1 wherein said substituted pyridine is isonicotinic acid (4-pyridinecarboxylic acid).

6. The continuous monitoring device of claim 1 wherein said methylenecarbonyl compound is barbituric acid.

7. The continuous monitoring device of claim 1 wherein said oxidizing agent is hypochlorite or chloramine-T.

8. The continuous monitoring device of claim 1 wherein said aqueous sample is initially delivered to said aqueous process stream at a flow rate in excess of 100 milliliters per hour to clean out all phases of the aqueous process stream and to introduce fresh aqueous sample.

9. The continuous monitoring device of claim 1 wherein said oxidizing agent is subsequently delivered to said third phase of said aqueous process stream after a residence time which is sufficient for the sample and said mixture of a buffered isonicotinic acid and barbituric acid to adequately mix in said first conduit.

10. The continuous monitoring device of claim 1 wherein said sample, said mixture of said dye precursors, and said oxidizing agent are delivered in a continuous cycle at fixed proportions.

11. The continuous monitoring device of claim 4 wherein the intensity of the cyanine dye formed is monitored and recorded by said color reading sensor.

12. The continuous monitoring device of claim 11 wherein the color reading sensor is an RGB color to frequency converter.

13. The continuous monitoring device of claim 11 wherein data from said color reader sensor are recorded for later analysis.

14. The continuous monitoring device of claim 13 wherein said data is directly output from said device.

15. The continuous monitoring device of claim 1 wherein said first, second, and third mechanisms are each a pump capable of delivering microliter to milliliter volumes.

16. The continuous monitoring device of claim 2 wherein said computer processor is capable of reading data output from said color reading sensor and for analyzing said data to determine whether a cyanide analyte or cyanogen analyte detection event occurs.

17. The continuous monitoring device of claim 16 further comprising a microcontroller for collecting and analyzing said data and for determining if said cyanide analyte or said cyanogen analyte is present in said sample by detecting a decrease in the color intensity.

18. The continuous monitoring device of claim 13 further comprising a command post computer interface for enabling the remote monitoring of said data recorded by one or more continuous monitoring devices.

19. The continuous monitoring device of claim 18 comprising a wireless communication module for providing real-time data monitoring of one or more continuous monitoring devices to a central monitoring facility.

20. The continuous monitoring device of claim 19 comprising a global positioning system module for remote deployment of multiple continuous monitoring devices to enable the determination of an exact location of said analyte contamination in a water network.

21. A method for detecting the presence or absence of cyanide or cyanogen chloride in an aqueous sample comprising:
delivering an aqueous sample to a first phase of a process stream wherein said aqueous sample that may or may not contain a cyanide or cyanogen analyte;
providing a first reservoir for containing a mixture of dye precursor compositions comprising a substituted pyridine compound and a methylenecarbonyl compound;
delivering said mixture of said dye precursor compositions from said first reservoir to said first phase of said aqueous process stream comprising said sample thereby forming a second phase of said aqueous process stream;
effecting mixing of said second phase for forming a mixed second phase;
delivering said mixed second phase of said aqueous process stream to a third phase of said aqueous process stream;
providing a second reservoir for containing an oxidizing agent;
delivering said oxidizing agent from said second reservoir to said third phase of said aqueous process stream either before, after or at the same time that said mixed second phase of said aqueous process stream is delivered to said third phase of said aqueous process stream;
providing a flow cell that is transparent to light and that is capable of receiving the third phase of said aqueous process stream containing said sample, said mixture, and said oxidizing agent;
delivering said third phase of said aqueous process stream containing said aqueous sample, said mixture, and said oxidizing agent to said flow cell for analysis;
providing a light source for delivering light to said flow cell;
delivering said light to said flow cell;
providing a color reading sensor for detecting the output reflectance intensity of said light delivered to said flow cell; and
detecting the output reflectance intensity of said light for determining the presence or absence of the cyanide analyte or the cyanogen chloride analyte in said aqueous sample.

22. The method of claim 21 comprising discharging the analyzed third phase of said aqueous process stream from said flow cell to form an effluent, and repeating the steps of claim 18 for one or more cycles for effecting a continuous monitoring of said aqueous sample.

23. The method of claim 21 comprising delivering said oxidizing agent to said third phase of said aqueous process stream after a residence time which is sufficient for said aqueous sample and a mixture of a buffered isonicotinic acid and barbituric acid to adequately mix in said second phase.

24. The method of claim 21 comprising providing a computer processor for storing and analyzing said output reflectance intensity and wherein said computer processor is capable of reading data output from said color reading sensor and for analyzing said data to determine whether a cyanide analyte or a cyanogen analyte or both of said analytes detection event occurs.

25. The method of claim 24 comprising providing a command post computer interface for enabling the remote monitoring of said data recorded by one or more continuous monitoring devices.

26. The method of claim 25 comprising providing a wireless communication module for providing real-time data monitoring of one or more continuous monitoring devices to a central monitoring facility.

27. The method of claim 26 comprising providing a global positioning system module for remote deployment of multiple continuous monitoring devices for enabling the determination of an exact location of said analyte contamination in a water network.
